(19) United States
(12) Patent Application Publication
(10) Pub. No.: US 2006/0203806 A1
(43) Pub. Date: Sep. 14, 2006

(54) Update method and system of a network device

(76) Inventor: Rong-Xing Tang, Hsichih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/285,037

(22) Filed: Nov. 23, 2005

(30) Foreign Application Priority Data
Mar. 11, 2005 (TW) 094138591

(51) Int. Cl. H04L 12/66

(52) U.S. Cl. 370/352; 370/401

(57) ABSTRACT

The update method and the system of the network devices are disclosed herein. The Session Initiation Protocol (SIP) is used in the network device to update the system. The user doesn't need to input the username and password when the user is going to sign in the SIP server. By using the SIP to identify the user, the network device is able to login easily. The transmitted information is encrypted to make sure the security during transmission.

### BACKGROUND OF THE INVENTION

1. Field of the Invention

The present invention generally relates to the system update method of a network device, and more particularly to the system update method of Internet Protocol (IP) phones by using Session Initiation Protocol (SIP).

2. Description of the Prior Art

For the time being, the system software, repairing program, and installation program, etc., for system updating is mostly over the Internet to be downloaded to user's location, and then to perform system updating, such as Windows Update, which performs system updating by self-defined mechanisms, so that its applications in fields and scopes are limited. With regard to the data transmission and system updating of the embedded devices, it is often necessary to take a complicated synchronous update procedure, such as the synchronous connection transmission between personal computers and pocket computers (Pocket PC). It doesn't fully take advantage of the merits of the Internet transmission. Because the information transmission and issue often require a security-guaranteed identification based on a username and password input by the user, it is heavy and complicated, and sometimes cannot assure the security during data transmission.

In terms of the drawbacks of the conventional update technologies, and the need for the convenient usage of the current network devices and IP phones, there is a need for the network devices and IP phones, which are able to simply and automatically proceed to update, burn, and install.

### SUMMARY OF THE INVENTION

The object of this invention is to provide a method for simple and automatic updating, burning, and installation. The present invention is by using Session Initiation Protocol (SIP) to update the system for the communication devices, and also to provide a single key to start automatic updating, burning and installation. Furthermore, the user doesn't need to input a username and password one by one to perform system updating of the communication devices, and it gets higher security during data transmission.

According to the aforementioned object, the communication device via the Gateway of SIP gets an Internet Protocol Address (IP address), and over the IP address the communication device can be connected to SIP server, and then after passing the user identification, the communication device can be connected to the SIP sever to locally perform system updating.

Session Initiation Protocol (SIP) is a fundamental instruction control protocol. SIP, whose framework is a peer-to-peer communication protocol, is a simple signal transport protocol for the interactive communication of Internet conference or IP phones. Accordingly, the system updating by SIP has the merits of security, encryption, convenience and simplicity.

### BRIEF DESCRIPTION OF THE DRAWINGS

FIG. 1 is a block diagram according to the embodiment of the present invention.

FIG. 2 is a flowchart according to the embodiment of the present invention.

FIG. 3 illustrates a client device locally and automatically updating system.

### DETAILED DESCRIPTION OF THE INVENTION

SIP is a protocol belonged to the Application Layer of the Open Systems Interconnection (OSI), a control protocol used to start, maintain and close a meeting. SIP, similar to Hyper Text Transfer Protocol (HTTP), adopts client-server framework. On the disposal of packet, SIP uses the existing packet information of HTTP. Accordingly, SIP is a transmission framework, well suitable to the Internet. The present invention takes advantage of this merit to perform system updating of the communication device by SIP.

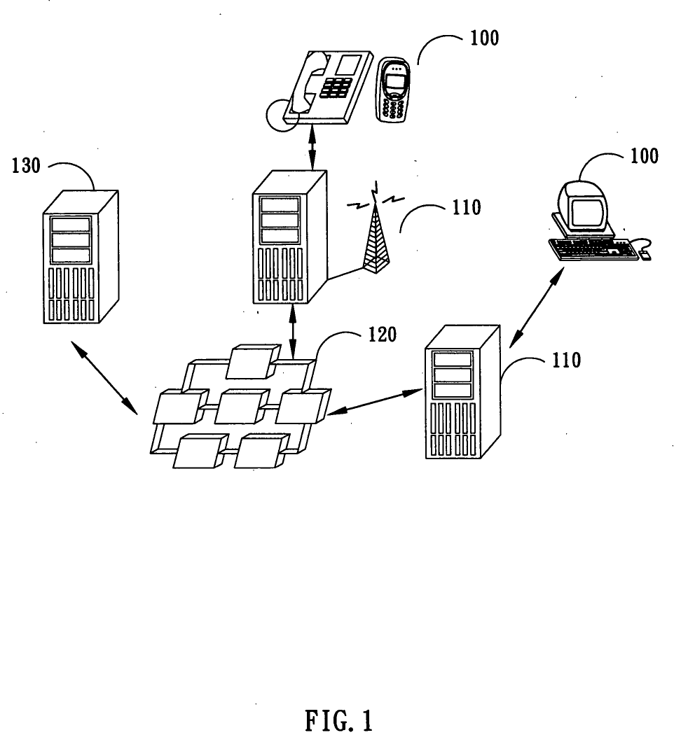

FIG. 1 is a block diagram according to the embodiment of the present invention. A communication device 100, via the gateway 110 of SIP, gets an Internet Protocol Address (IP address) 120. The communication device 100 can be connected to the SIP server 130 via the IP address 120. After the user identification, the communication device 100 is connected to the SIP server 130 to perform system updating. According to the embodiment of the present invention, the communication device 100 can be a wire communication device such as desktop computers, notebook computers, or Internet accessible telephones, etc.; or a wireless communication device such as wireless mobile IP phones (WiFi phone) or Personal Digital Assistants (PDA), etc. When the communication device 100 is connected to the Internet via SIP, it can perform system updating.

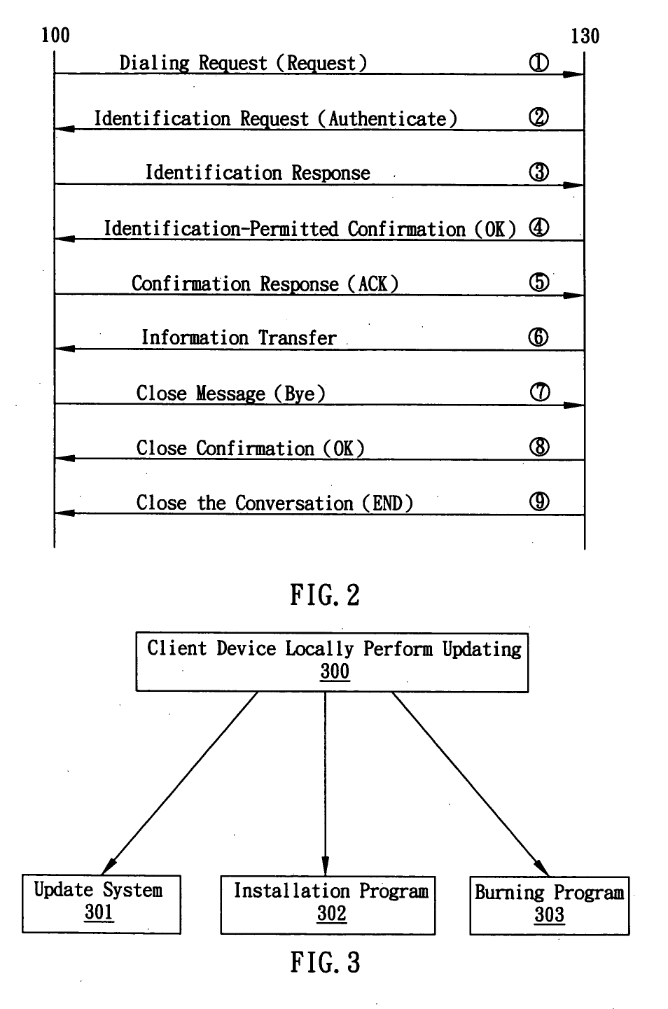

FIG. 2 is a flowchart according to the embodiment of the present invention. First, the communication device 100 at the client side, such as Voice over IP (VOIP) phones, sends a dialing request (or called login request, abbreviated as Request) to the service provider 130, such as SIP server or SIP Proxy server. In the embodiment, the client 100, SIP phone, dials a SIP phone number to the service provider 130.

After the service provider (SIP server) 130 receives the request, it will send a signal to request the other side to perform identification, called Authenticate. (Step 2) For example, the service provider 130 requests the other side to perform an identification encrypted by MD5.

Then, in order to answer the identification request, the client 100 will send a signal with personal identification information, called identification response. (Step 3) Follow the previous example, the client 100 will send a signal with personal identification information encrypted by MD5 to the service provider 130.

After receiving the identification response, the service provider 130 will perform an examination. After passing the examination, it will send a pass signal (OK), or an identification-permitted confirmation. (Step 4) If the examination is not passed, the service provider 130 will send a warning signal or prepare to close the connection. Because this part is not the characteristic of the present invention, it is not illustrated in the figure, and any further description will not be given any more.

After receiving an identification-permitted confirmation (OK), the client 100 also needs to send a confirmation response (ACK) (Step 5) to the service provider 130, so that the service provider can make sure that the other side has already received. So far, after the completion of the identification and system login, both of the client 100 and the service provider 130 formally establish a connection.

Then, under such a secure encrypted connection, the service provider 130 is able to perform a series of transfers of data and information needed for system updating in the embodiment of the present invention. (Step 6) The aforementioned steps are to establish the interactive connection by SIP. For the current step, it is necessary to use other protocols to complete the information transmission. For example, Session Description Protocol (SDP) is used to achieve synchronization, and furthermore Real-Time Transport Protocol (RTP) is used to transmit real data and information.

When the client 100 wants to close this connection, the service provider is informed by the close signal (Bye) defined by SIP. (Step 7) The service provider 130 sends a close confirmation signal (OK) (Step 8), and then closes this transmission and connection (END). (Step 9)

After the data transmission is completed and the connection is closed, the network communication device at client side automatically updates the system 300, as shown in FIG. 3. The embodiment of the present invention includes one of three update methods. The first update method 301 is by copying the received update information to a directory on the system to automatically cover the original system program. The covering method is by using the traditional method, such as Windows Update. The second update method 302 is by using the received packet to install and update the system. The third update method 303 is by burning the received program to the firmware storage location on the embedded device.

According to the above-mentioned disclosed update method and the system of the present invention, several exemplary applications will be illustrated as follows. In the first exemplary application, add an UPDATE key to a wireless mobile IP phone. When the user presses the UPDATE key, the device is connected to the SIP server over the authenticated user account number, and after the communication connection is established, the wireless mobile IP phone by using Session Description Protocol (SDP) transmits the system update program. When the transmission is completed, the IP phone itself updates the system automatically. In this exemplary application, SIP is used for initiation. The real transfer of information or voice is synchronized via Session Description Protocol (SDP). Finally, both sides use the appointed protocol to communicate, and use Real-Time Transport Protocol (RTP) to transfer information such as real text, voice, video, etc.

In the second exemplary application, the user installs the application software accessible via SIP to desktop computers, notebook computers, Internet accessible Personal Digital Assistants (PDA), or other Internet accessible devices. After connection to the SIP server, the server authenticates the user. By the secure method, complete the transmission of the application program for system updating. After the data transmission, the software automatically performs system updating and installation.

According to the embodiment of the present invention, during the information transmission between the server and the communication device, SIP is able to cooperate with Security Socket Layer (SSL), Transport Layer Security (TLS), or other secure transfer methods to transfer the needed information to the designated location to make sure the security during information transfer.

Although specific embodiments have been illustrated and described, it will be appreciated by those skilled in the art that various modifications may be made without departing from the scope of the present invention, which is intended to be limited solely by the appended claims.

What is claimed is:

1. A system update method of a network device, comprising:
establishing a connection between a network device at client side and a service provider;
transmitting a system update information to said network device;
ending said connection; and
updating system locally on said network device

2. The system update method of the network device according to claim 1, wherein the establishment of said connection comprises:
sending a dialing signal from said network device to said service provider.

3. The system update method of the network device according to claim 2, after sending the dialing signal, further comprising:
said service provider sending an identification request to said network device;
said network device sending an identification response to said service provider; and
said service provider examining and confirming said identification response.

4. The system update method of the network device according to claim 3, wherein said identification response comprises an encrypted personal identification information of said client side.

5. The system update method of the network device according to claim 1, wherein the establishment of said connection complies with Session Initiation Protocol (SIP).

6. The system update method of the network device according to claim 5, wherein the transmission of said system update information is synchronized by using Real-Time Transport Protocol (RTP).

7. The system update method of the network device according to claim 1, wherein said local system updating of said network device copies said system update information to system directory on said network device, and then automatically covers original system program.

8. The system update method of the network device according to claim 1, wherein said local system updating of said network device automatically installs received system update information to said network device.

9. The system update method of the network device according to claim 1, wherein said local system updating of said network device burns said system update information to firmware storage location of said network device.

10. A system capable of automatically and directly performing system updating, comprising:
a network device at client side;
a service provider, after the connection is established between said network device and said service provider, said service provider transmitting system update information to said network device, and said network device locally performing system updating.

11. The system capable of automatically and directly performing system updating according to claim 10, wherein the establishment of said connection comprises:
sending a dialing signal from said network service to said service provider.

12. The system capable of automatically and directly performing system updating according to claim 11, after sending the dialing signal, further comprising:
said service provider sending an identification request to said network device;
said network device sending an identification response to said service provider; and
said service provider examining and confirming the identification response.

13. The system capable of automatically and directly performing system updating according to claim 12, after sending the dialing signal, wherein said identification response comprises an encrypted personal identification information.

14. The system capable of automatically and directly performing system updating according to claim 10, wherein said connection is established by using SIP.

15. The system capable of automatically and directly performing system updating according to claim 14, wherein transmission of said system update information is synchronized by using Session Description Protocol (SDP).

16. The system capable of automatically and directly performing system updating according to claim 10, wherein said network device comprises a system directory, and said system update information is copied to said system directory to automatically cover original system program.

17. The system capable of automatically and directly performing system updating according to claim 10, wherein said local system updating of said network device is to automatically proceed to install the received system update program to said network device.

18. The system capable of automatically and directly performing system updating according to claim 10, wherein said network device comprises a firmware storage location, to which said system update information is automatically burned.

19. A network device capable of automatically and directly performing system updating, executing the following steps:
establishing a connection with a service provider, and receiving system update information transmitted from said service provider;
closing said connection; and
performing system updating locally at said network device.

20. The network device capable of automatically and directly performing system updating according to claim 19, wherein the establishment of said connection complies with SIP.
